(19) United States
(12) Patent Application Publication
(10) Pub. No.: US 2016/0306971 A1
(43) Pub. Date: Oct. 20, 2016

(54) AUTOMATED IDENTIFICATION AND REVERSE ENGINEERING OF MALWARE

(71) Applicant: Los Alamos National Security, LLC, Los Alamos, NM (US)

(72) Inventors: Blake Anderson, San Jose, CA (US); Curtis Storlie, Los Alamos, NM (US); Joseph Sexton, Los Alamos, NM (US)

(73) Assignee: Los Alamos National Security, LLC, Los Alamos, NM (US)

(21) Appl. No.: 15/098,422

(22) Filed: Apr. 14, 2016

Related U.S. Application Data
(60) Provisional application No. 62/147,843, filed on Apr. 15, 2015.

(51) Int. Cl. G06F 21/56; G06N 7/00; G06N 99/00

(52) U.S. Cl. CPC G06F 21/563; G06N 99/005; G06N 7/005

(57) ABSTRACT

An automated malware identification and reverse engineering tool is provided. Subroutine categories may be learned by machine learning. A program may then be reverse-engineered and classified, and subroutines that are potentially indicative of malware may be identified. These subroutines may be reviewed by a reverse engineer to determine whether the program is malware in a more directed and efficient manner.

### CROSS REFERENCE TO RELATED APPLICATION

This application claims the benefit of U.S. provisional patent application No. 62/147,843 filed on Apr. 15, 2015. The subject matter of this earlier filed application is hereby incorporated by reference in its entirety.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD

The present invention generally relates to detecting malware, and more particularly, to automated identification and reverse engineering of malware.

### BACKGROUND

Over 100 million unique variants of malware are created every year, with McAfee® logging over 30 million new samples in the first quarter of 2014 alone. The majority of this malware is created through relatively simple modifications of known malware. Such malware is not intended to subvert sophisticated security procedures. However, unlike the overwhelming majority of variants of malware, Advanced Persistent Threat (APT) malware APT malware is created with the intention to target a specific network or set of networks and has a precise objective, e.g., setting up a persistent beaconing mechanism or exfiltration of sensitive data. As such, APT may be the most damaging for companies, government agencies, and other organizations. For instance, in an APT attack on Home Depot® in 2014 that lasted for approximately five months, 56 million cards may have been compromised. Other companies that have experienced APT attacks recently include Target®, Neiman Marcus®, Supervalu®, P.F. Chang's®, and likely J.P. Morgan Chase®. Because APT malware is much more dangerous, most incident response teams of large networks have several reverse engineers on hand to deal with these threats.

A reverse engineer has the task of classifying the hundreds to thousands of individual subroutines of a program into the appropriate classes of functionality. With this information, reverse engineers can then begin to decipher the intent of the program. This is a very time consuming process, and can take anywhere from several hours to several weeks, depending on the complexity of the program. In conjunction with classifying the subroutines, the entire process can take weeks or months. At the same time, reversing APT is a time-critical process, and understanding the extent of an attack is of paramount importance.

While 0-day malware detectors are a good start, they do not help reverse engineers to better understand the threats attacking their networks. Understanding the behavior of malware is often a time-sensitive task, and can take anywhere between several hours to several weeks. Accordingly, a malware identification technology that automates the task of identifying the general function of the subroutines in the function call graph of the program to aid reverse engineers may be beneficial.

### SUMMARY

Certain embodiments of the present invention may provide solutions to the problems and needs in the art that have not yet been fully identified, appreciated, or solved by conventional malware identification technologies. For example, some embodiments of the present invention pertain to software, hardware, or a combination of software and hardware that automatically reverse engineers a selected program and categorizes each subroutine.

In an embodiment, a computer-implemented method includes automatically labeling each subroutine in a program, by a computing system, in a function call graph. The computer-implemented method also includes applying a probabilistic approach to identify at least one subroutine as potentially indicative of malware. The computer-implemented method further includes providing an indication of the at least one identified subroutine, by the computing system, to an analyst for further analysis.

In another embodiment, a computer program is embodied on a non-transitory computer-readable medium. The computer program is configured to cause at least one processor to receive a training program and list of subroutines labeled in a plurality of categories. The computer program is also configured to cause the at least one processor to learn an identification strategy of how to identify the categories based on the received subroutines and labels. The computer program is further configured to cause the at least one processor to label new subroutines based on the learned identification strategy.

In yet another embodiment, an apparatus includes memory storing computer program instructions and at least one processor configured to execute the stored computer program instructions. The at least one processor, by executing the stored computer program instructions, is configured to receive a training program and list of subroutines labeled in a plurality of categories. The at least one processor is also configured to learn an identification strategy of how to identify the categories based on the received subroutines and labels. The at least one processor is further configured to automatically label new subroutines in a function call graph based on the learned identification strategy. Additionally, the at least one processor is configured to apply a probabilistic approach to identify at least one subroutine as potentially indicative of malware.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a screenshot of a function call graph from the IDA Pro® assembler and debugger.

FIG. 2 is a flowchart illustrating a process for training malware identification software, according to an embodiment of the present invention.

FIG. 3 illustrates a table of example assembly instructions and a subroutine graph.

FIG. 4 is a tree illustrating neighbor information that was used in an example, according to an embodiment of the present invention.

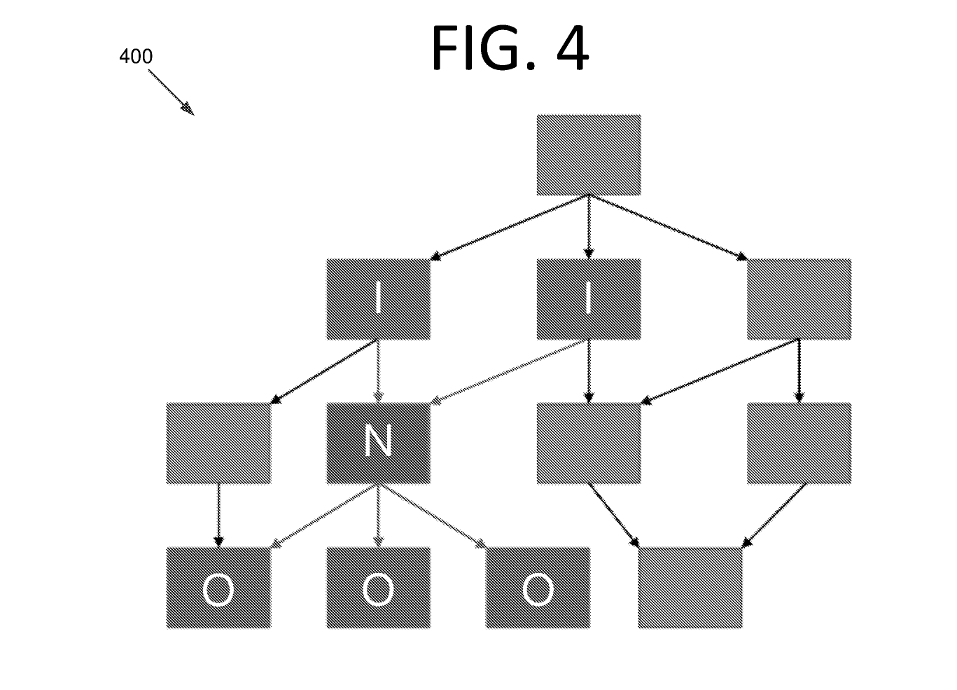

FIG. 5A is a kernel heatmap illustrating instructions, according to an embodiment of the present invention.

FIG. 5B is a kernel heatmap illustrating API calls, according to an embodiment of the present invention.

FIG. 5C is a kernel heatmap illustrating a combined kernel with both instructions and API calls, according to an embodiment of the present invention.

FIG. 6 is a histogram illustrating the predicted probability of the true class using only the instruction view, according to an embodiment of the present invention.

FIG. 7 is a histogram illustrating the predicted probability of the true class for SVM using the instruction view and the API call view, according to an embodiment of the present invention.

FIG. 8 is a histogram illustrating the predicted probability of the true class for SVM using the instruction view, the API call view, and the neighbor view for the Gaussian process, according to an embodiment of the present invention.

FIG. 9 is a screenshot illustrating a prototype GUI, according to an embodiment of the present invention.

FIG. 10 is a flowchart illustrating a processor for learning categories and identifying subroutines that are potentially indicative of malware, according to an embodiment of the present invention.

FIG. 11 is a block diagram of a computing system configured to learn subroutine categories and identify malware, according to an embodiment of the present invention.

### DETAILED DESCRIPTION OF THE EMBODIMENTS

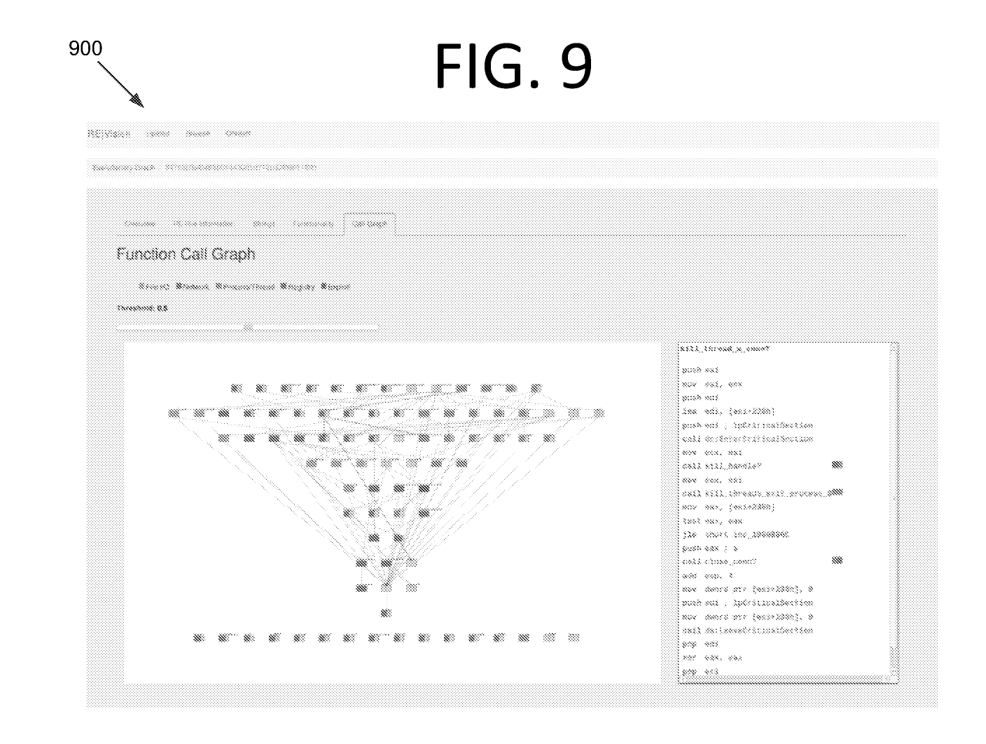

Some embodiments of the present invention pertain to software, hardware, or a combination of software and hardware that automatically reverse engineers a selected program and categorizes each subroutine. There are certain subroutines that make a program look like malware. These subroutines that make the program potentially malicious may be clustered into a group (i.e., a subgraph). These subgraphs may be highlighted for reverse engineers, as shown in screenshot 900 of FIG. 9.

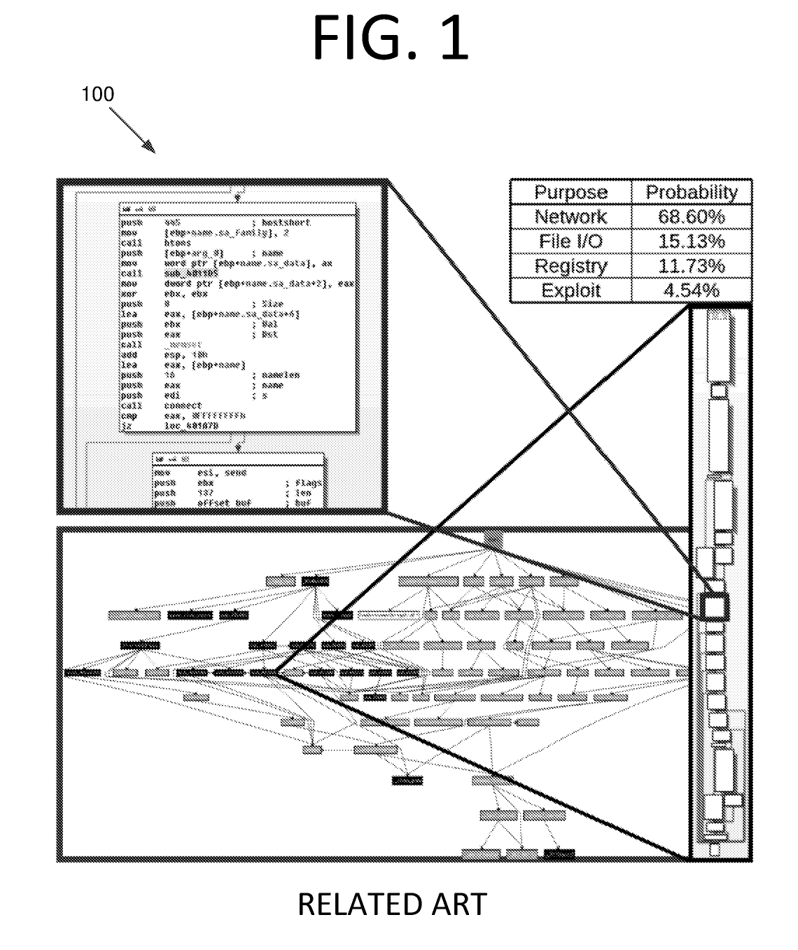

Reverse engineers can see the big picture of where the program is doing what in such embodiments, as well as see precisely where the program looks malicious. For instance, network, registry, and/or file input/output (I/O) categories may be particularly suspect, and a reverse engineer may be notified of the location of these categories for more targeted, efficient, and effective analysis. This potentially reduces the time required to reverse engineer malware from weeks or months to hours or days. Conventional analysis software, such as IDA Pro®, performs visual analysis providing a flow graph where users can click subroutines to see opcodes. See screenshot 100 of FIG. 1.

However, no further information is provided. For instance, conventional analysis software does not provide categories, highlight subgraphs of malicious activity, show in a subgraph which subroutines are calling which and their associations, or show that the subroutines are characteristic of APT malware. Most of a malicious program looks benign. Only a handful of subroutines are performing the malicious behavior. Thus, conventional analysis software is highly inefficient.

In some embodiments, and unlike conventional analysis software, each subroutine is automatically labeled in a function call graph. The use of a probabilistic approach to find signatures of malware is also a novel feature of some embodiments that is lacking from conventional analysis software. The subroutine label may be modeled using a multiclass Gaussian process or a multiclass support vector machine giving the probability that the subroutine belongs to a certain class of functionality (e.g., file I/O, exploit, etc.). A multiview approach may be used to construct the subroutine kernel (or similarity) matrix for use in the classification method. The different views may include the instructions contained within each subroutine, the Application Programming Interface (API) calls contained within each subroutine, and the subroutine's neighbor information.

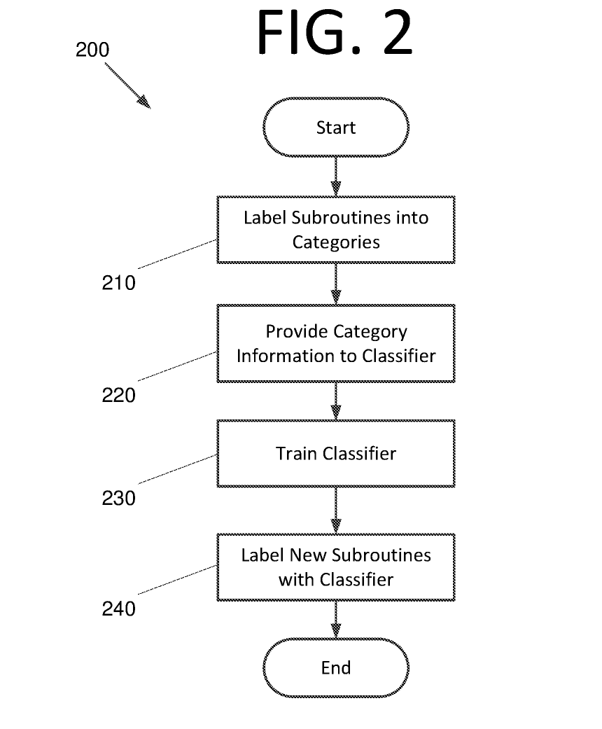

FIG. 2 is a flowchart 200 illustrating a process for training malware identification software, according to an embodiment of the present invention. The process begins with a skilled reverse engineer labeling subroutines into general, predefined categories at 210. The categories being used in some embodiments include, but are not limited to, file I/O, process/thread, network, Graphical User Interface (GUI), registry, and exploit. The category information be provided to a classifier at 220 and the classifier may be trained at 230 using the provided category information. This trained classifier may then be used to label new subroutines at 240. Some promising initial results illustrating the effectiveness of this approach were presented in a sample of 201 subroutines taken from two malicious families.

Data

Three views of data, and their corresponding representations, are described below. The first two views, which are assembly instructions and API calls, have been studied extensively in the literature and have been shown to have strong discriminatory power in the malware-versus-benign classification problem. The neighbor information view has had less exposition, mainly due to subroutine classification being a novel problem that is first addressed herein. The data was collected using an IDA Pro® disassembly of the programs.

201 subroutines were collected and classified as one of six possible categories: file I/O, process/thread, network, GUI, registry, and exploit. These subroutines came from two APT malware families and some randomly selected benign programs. The benign programs were mainly used to obtain more examples of the GUI category. There were 32 programs in total, and the number of each class of subroutines is given below in Table 1.

TABLE 1
NUMBER AND CLASS OF SUBROUTINES IN SAMPE PROGRAMS

| Type: | # of Examples: |
|---|---|
| File I/O | 44 |
| Process/Thread | 42 |
| Network | 70 |
| GUI | 21 |
| Registry | 18 |
| Exploit | 6 |

Instructions

Assembly instructions have had considerable exposure in the literature. This is a fundamental view of subroutines that is used herein. The assembly instructions are first categorized, i.e., there is a set number of classes of instructions and all instructions that are seen fall into one of the categories. 86 classes of instructions were used in some embodiments, which are based on the “pydasm” instruction types. Categorizations are used because there are a large number of semantically similar instructions (e.g., add and fadd), and this helps to limit the feature space to a more manageable size.

There are several methods that can be used to represent the assembly instructions. The first method that was experimented with was simply as representing the instructions sequences and then using a sequence alignment algorithm to compare the subroutines. This seems to be the most intuitive method. However, it yielded poor results and was orders of magnitude slower than more optimal methods.

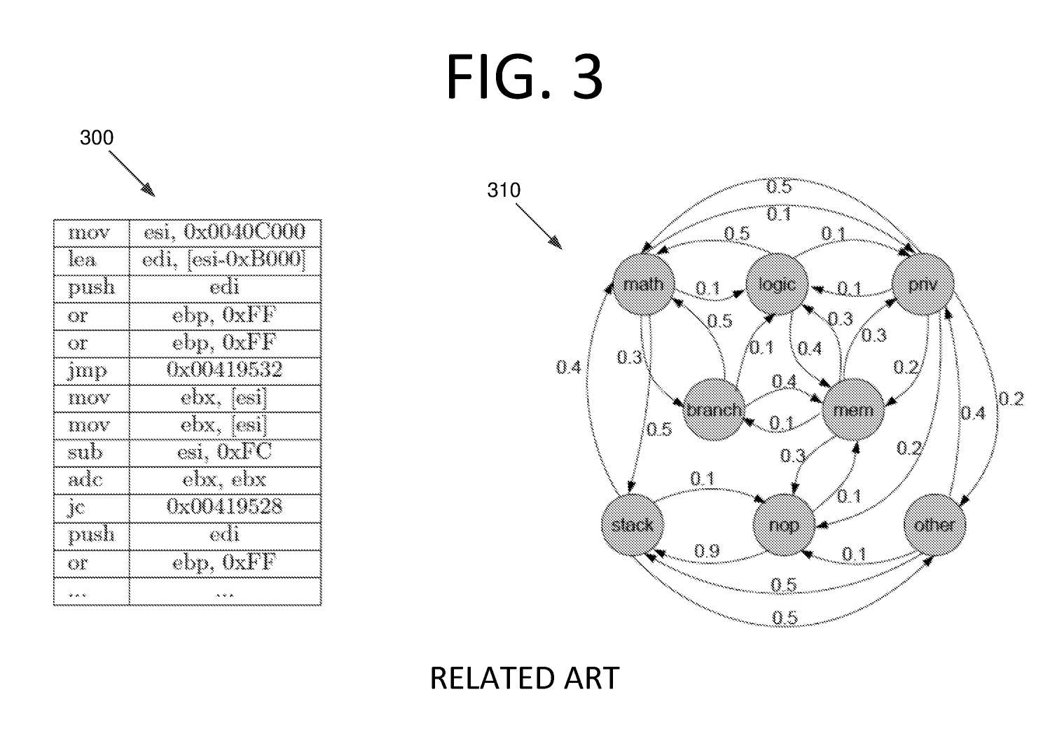

Because the sequence alignment method did not work well, the instructions were modeled as a Markov chain with the instruction categories as the nodes of the Markov chain graph. In the Markov chain representation, the edge weight eᵢⱼ between vertices i and j corresponds to the transition probability from state i to state j. Therefore, the edge weights for edges originating at vᵢ are required to sum to 1, Σ_{i→j}eᵢⱼ=1. An n×n (n=|V|) adjacency matrix is used to represent the graph, where for each entry aᵢⱼ in the matrix, aᵢⱼ=eᵢⱼ. An example is shown in FIG. 3, which shows a table of example assembly instructions 300 and a subroutine graph 310 on an eight category representation for ease of illustration.

API Calls

When a reverse engineer begins the process of understanding the functionality of a program, the API calls performed within the subroutine may be highly informative. For instance, “wininet.dll” contains API calls that are exclusively used for network activity. This is a good indicator that the subroutine containing those calls is related to network functionality. The efficacy of API calls for the program classification problem has been shown in other work. The dataset here contains 791 unique API calls from 22 unique Digital Link Libraries (DLLs). Several methods were tried to encode the information from the API calls, notably using a feature vector of length 791 for each unique API call and a feature vector of length 22 for each unique DLL. Based on early results, the feature vector of length 22 was used, where each entry in the vector corresponds to the count of calls to that specific DLL within the subroutine.

Neighbor Information

Although API calls are informative, there exists a large number of subroutines that do not contain any API calls. This prompted the use of neighborhood information in some embodiments, with the assumption that the neighboring subroutines of subroutine x will be likely to perform a similar function to the neighboring subroutines of subroutine y, given that x and y have the same label. Two views were constructed with the neighbor information—the incoming and outgoing neighbor views. Similar to the API calls, a feature vector of length 22 for the 22 unique DLLs was used for each view. The incoming view was constructed by counting all unique DLLs in every incoming subroutine and setting the appropriate entry in the feature vector. For example, in tree 300 of FIG. 3, for a given node “N,” the incoming nodes “I” and the outgoing nodes “O” are used. The counts of the DLLs in the subroutines of the incoming nodes may be used to construct the feature vector. The outgoing neighbor view may be constructed in an analogous manner.

Methods

Kernel-based classifiers have been shown to perform well on a wide variety of tasks. In some embodiments, support vector machines and Gaussian processes are used to classify the subroutines. These methods are related, and both rely on kernel matrices to perform their respective optimizations.

Kernels

A kernel K(x, x′) is a generalized inner product that can be thought of as a measure of similarity between two objects. A useful aspect of kernels is their ability to compute the inner product between two objects in a possibly much higher dimensional features space. A kernel K: X×X→ [symbol] is defined as

K(x,x′)= [symbol] φ(x),φ(x′) [symbol] (1)

where [symbol] •,• [symbol] is the dot product and φ(•) is the projection of the input object into feature space. A well-defined kernel must satisfy two properties: (1) it must be symmetric, i.e., for all x and x′εX:K(x, x′)=K(x′, x); and (2) it must be positive semi-definite, i.e., for any x₁, . . . , xₙεX and cε [symbol] ⁿ:Σᵢ₌₁ⁿΣⱼ₌₁ⁿcᵢcⱼK(xᵢ,xⱼ)≧0. Kernels are appealing in a classification setting due to the kernel trick, which replaces inner products with kernel evaluations. The kernel trick uses the kernel function to perform a non-linear projection of the data into a higher dimensional space, where linear classification in this higher dimensional space is equivalent to non-linear classification in the original input space.

If each view above is treated as a feature vector, a Gaussian kernel can be defined:

K(x,x′)=σ²e^{-λd(x,x′)}^{²} (2)

where x and x′ are the feature vectors for a specific view, σ and λ are the hyperparameters of the kernel function determined through cross-validation or Markov Chain Monte Carlo (MCMC), and d(•,•) is the distance between two examples. The Euclidean distance is used for d(•,•).

Support Vector Machine Classification

A Support Vector Machine (SVM) searches for a hyperplane in the feature space that separates the points of the two classes with a maximal margin. The hyperplane that is found by the SVM is a linear combination of the data instances xᵢ with weights αᵢ. It should be noted that only points close to the hyperplane will have non-zero α values. These points are called support vectors. Therefore, the goal in learning SVMs is to find the weight vector a describing the contribution of each data instance to the hyperplane. Using quadratic programming, the following optimization problem can be efficiently solved as:

$${max}_{α} ( {\sum }_{i = 1}^{n} {α}_{i} - \frac{1}{2} {\sum }_{i = 1}^{n} {\sum }_{j = 1}^{n} {α}_{i} {α}_{j} {y}_{i} {y}_{j} K ( {x}_{i} , {x}_{j} ) ) \qquad ( 3 )$$

subject to the constraints:

$${\sum }_{i = 1}^{n} {α}_{i} {y}_{i} = 0 \qquad ( 4 )$$

0≦αᵢ≦C (5)

Given a found in Eq. (3), the decision function is defined as:

$$f ( x ) = sgn ( {\sum }_{i}^{n} {α}_{i} {y}_{i} K ( x , {x}_{i} ) ) \qquad ( 6 )$$

which returns class +1 if the summation is ≧0, and class −1 if the summation <0. The number of kernel computations in Eq. (6) is decreased because many of the α values are zero.

To perform multiclass classification with the support vector machine, a one-versus-all strategy is used. A classifier is trained for each class resulting in l scores, where l is the number of classes (in this case, 6). This list of scores can then be transformed into a multiclass probability estimate by standard methods.

Gaussian Classification

Gaussian processes are a good probabilistic alternative to support vector machines for kernel learning. A Gaussian process can be completely specified by a mean function m and covariance (kernel) function K, although the mean function is often taken to be zero without loss of generality. For multiclass classification, a multinomial logistic Gaussian process regression is used. For each class label l, define

fₗ˜GP(0,K) (7)

to be an independent Gaussian process with covariance matrix K and positive training examples belonging to class l. Let pₗ(x) be the probability of x belonging to the l^{th} class, defined as

$${p}_{l} ( x ) = \{ \begin{matrix}\frac{exp {f}_{l} ( x )}{1 + {\sum }_{l = 1}^{L - 1} exp {f}_{l} ( x )} & for l = 1 , … , L - 1 \\ \frac{i}{1 + {\sum }_{l = 1}^{L - 1} exp {f}_{l} ( x )} & for l = L\end{matrix} \qquad ( 8 )$$

p(x) is now a probability vector containing the probabilities of belonging to each of the L classes.

The fₗ(x) are then conditioned on the training tables y, and a posterior distribution is obtained for fₗ(x), and thus p(x), at the training points. This is accomplished via MCMC methods. Prediction of new observations x₊ is then conducted by obtaining the predictive fₗ(x₊) by conditioning on the estimated fₗ corresponding to the training data.

fₗ(x₊)=K₊(K+σₙ_{₂}I)⁻¹fₗ (9)

Combining Information

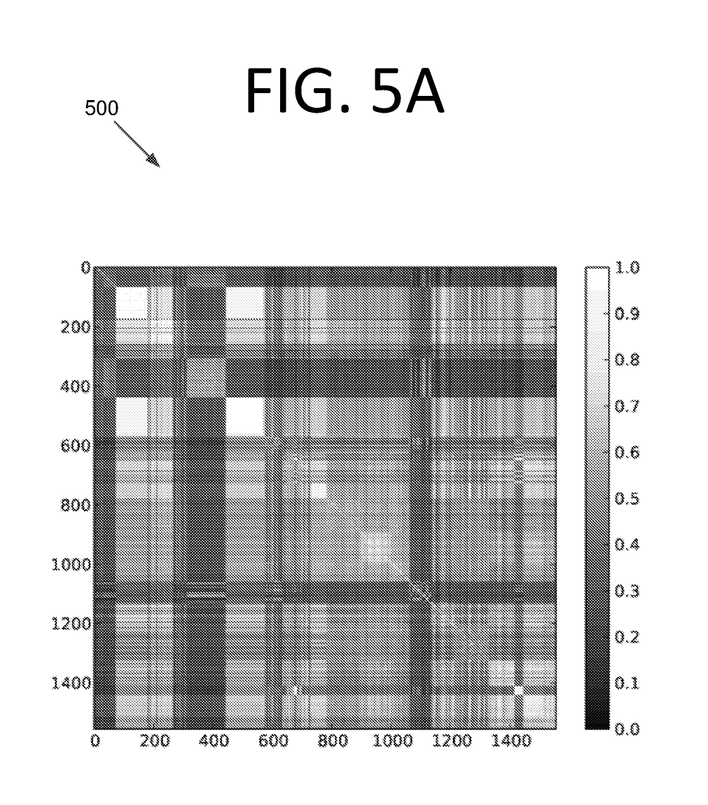

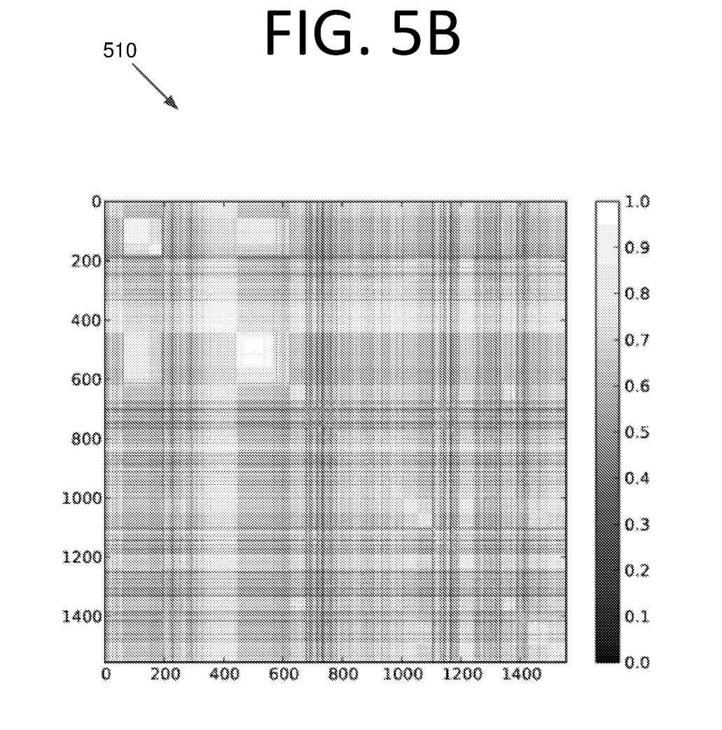

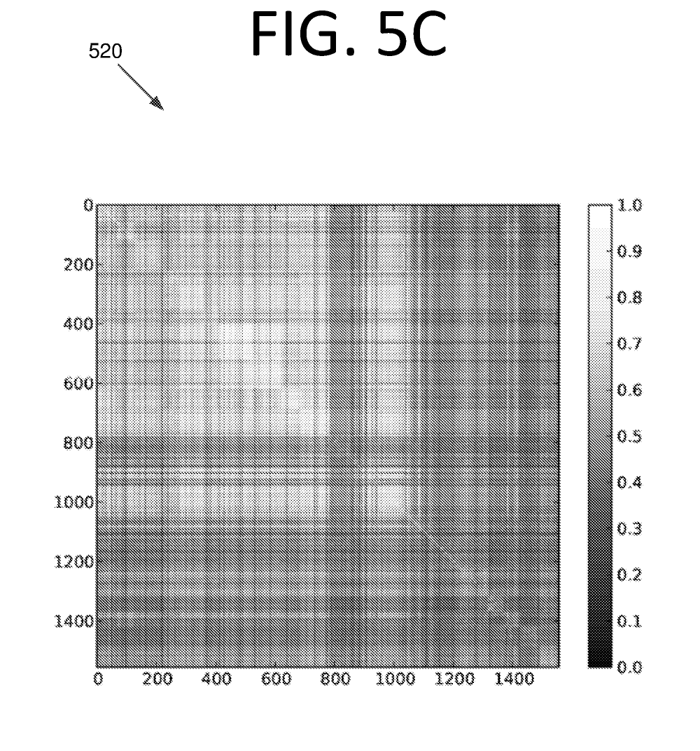

Combining multiple views has been shown to be advantageous for the malware-versus-benign classification problem. For this reason, and the intuitive reasons outlined above, multiple views of subroutines are included in the models. For SVMs, this can be accomplished with multiple kernel learning. For the Gaussian processes approach used here, a new kernel can be defined over multiple views via product correlation (i.e., taking a product of the kernels for the individual views). Heatmaps 500, 510, 520 of FIGS. 5A-C, respectively, give an intuitive example of the benefits gained by using multiple views. Heatmaps 500, 510 in FIGS. 5A and 5B are distinct views of the instructions and API calls, respectively. Combining these views, as in heatmap 520 of FIG. 5C, in a sense “smooths” the kernel space, allowing for better predictive accuracy.

Combining Information with a Support Vector Machine

With multiple kernel learning, the contribution of each individual kernel β must also be found such that

$$K ( x , {x}^{′} ) = {\sum }_{i = 1}^{M} {β}_{i} {K}_{i} ( x , {x}^{′} ) \qquad ( 10 )$$

is a convex combination of M kernels with βᵢ≧0, where each kernel Kᵢ uses a distinct set of features. In the instant case, each distinct set of features is a different view of the data, per the above. The general outline of the algorithm is to first combine the kernels with βᵢ=1/M, find α, and then iteratively continue optimizing for β and α until convergence. β can be solved for efficiently using a semi-finite linear program.

Combining Information with Gaussian Processes

Learning with multiple views in the Gaussian process is conceptually simpler in some respects, although it can be more computationally demanding. First, Eq. (2) may be modified to take the multiple views into account. This involves defining a distance function on each view (e.g., dⱼ(x, x′)²) for the j^{th} view where in this case dⱼ is the Euclidean distance. If there are M views, the new multiview kernel is defined as:

$$K ( x , {x}^{′} ) = {σ}^{2} {e}^{- {\sum }_{j}^{M} {λ}_{j} {{d}_{j} ( x , {x}^{′} )}^{2}} \qquad ( 11 )$$

The Δⱼs now act as a way to combine the different metric spaces of the subroutines, similar to how the β weight vector works in the multiple kernel learning method. The λⱼs are now also optimized over within the same framework as the other parameters of the Gaussian process model using MCMC sampling. Eq. (10) may be used in place of Eq. (11) within the same framework, but Eq. (11) was found to produce better results.

Results

Several experiments were performed to test how well the methods described above perform on the multiclass subroutine classification problem. 10-fold cross validation (CV) was used for all experiments, unless otherwise stated. Within each fold, the parameters of the models were adjusted using 10-fold CV on the training data while the original hold-out was used for validation. A dataset of 201 subroutines was collected what were assigned one of the six labels from Table 1. Subroutines that perform multiple functions were excluded, and the problem of estimating subroutines belonging to multiple classes is not considered here. For the SVM, the Shogun machine learning toolbox was used. The Bayesian multiclass logistic Gaussian process was custom-coded.

Classifying Subroutines

The first set of experiments examines the plausibility of classifying subroutines using the approach of some embodiments. Using just the instructions, an accuracy of 94-97% was achieved with 10-fold CV. Table 2 below shows the full test results.

TABLE 2
10-FOLD CV TEST RESULTS

| | | | Average Probability |
|---|---|---|---|
| Method: | Views: | Accuracy: | of True: |
| SVM | Instructions | .9403 | .8903 |
| GP | Instructions | .9701 | .8075 |
| SVM | API Calls | .8159 | .7857 |
| GP | API Calls | .8159 | .7609 |
| SVM | API Calls, Neighbor | .9403 | .8703 |
| | Information | | |
| GP | API Calls, Neighbor | .9154 | .8443 |
| | Information | | |
| SVM | Instructions, API Calls | .9851 | .9169 |
| GP | Instructions, API Calls | .9851 | .8988 |

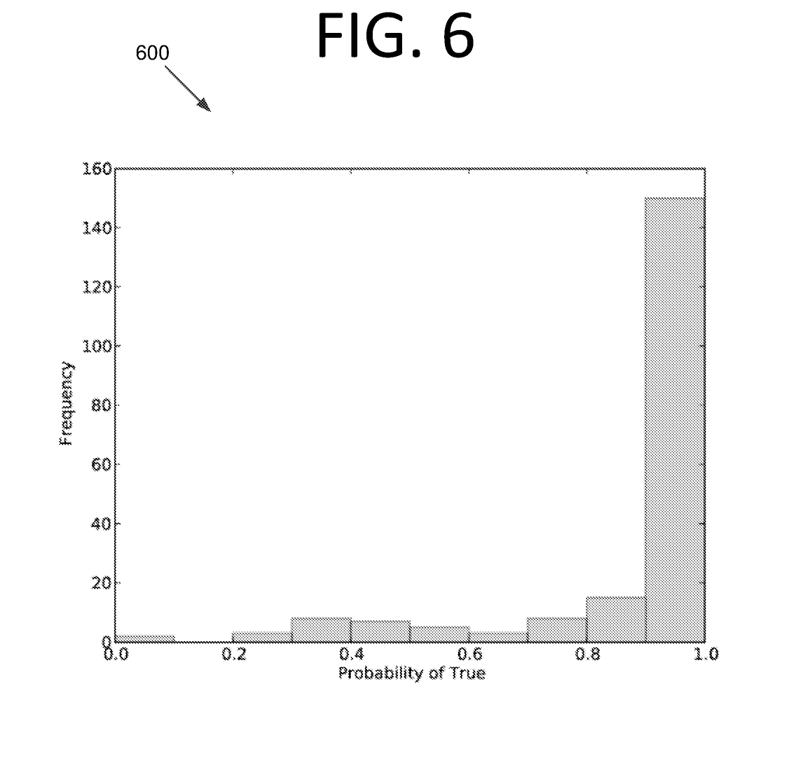

The average probability of true is even more impressive than raw accuracy. To reiterate, the SVM and Gaussian process methods return a probability vector of that subroutine belonging to each of the six classes. The average probability of true in Table 2 refers to the predicted probability of the true class averaged over all predictions. The average probability of true, using only the instructions, is 0.8075 for the Gaussian process and 0.8903 for the SVM. A histogram 600 of these probabilities is shown in FIG. 6.

While all subroutines were not classified correctly, the probability of the class can act as a pseudo-confidence for a reverse engineer looking at the results. As FIG. 6 demonstrates, the subroutine's true class is predicted a 90-100% accuracy approximately 75% of the time. In a sense, false predictions can be more harmful in this setting than the malware-versus-benign setting as a false prediction can give false leads to the reverse engineer, potentially wasting days of his or her time. By giving the probability vector of belonging to the different types of functionality, the reverse engineer can have some confidence of the predictions by focusing on the subroutines with 90-100% probability.

As mentioned above, API calls are informative for a reverse engineer trying to understand a subroutine. API calls often clearly encode the type of functionality that a subroutine performs as the DLL from which the API call is imported from is usually homogeneous, i.e., it contains functions that perform one type of functionality, such as network. Unfortunately, API calls are not guaranteed to be in subroutines. In the dataset above, only 163 out of the 201 subroutines contained API calls. Table 2 demonstrates the pitfall in only using API calls, as instruction-only classifiers are easily able to outperform API-only classifiers. However, including the API information of neighbors of subroutines significantly improves performance. For instance, for SVM, performance improved from 0.8159 to 0.9403.

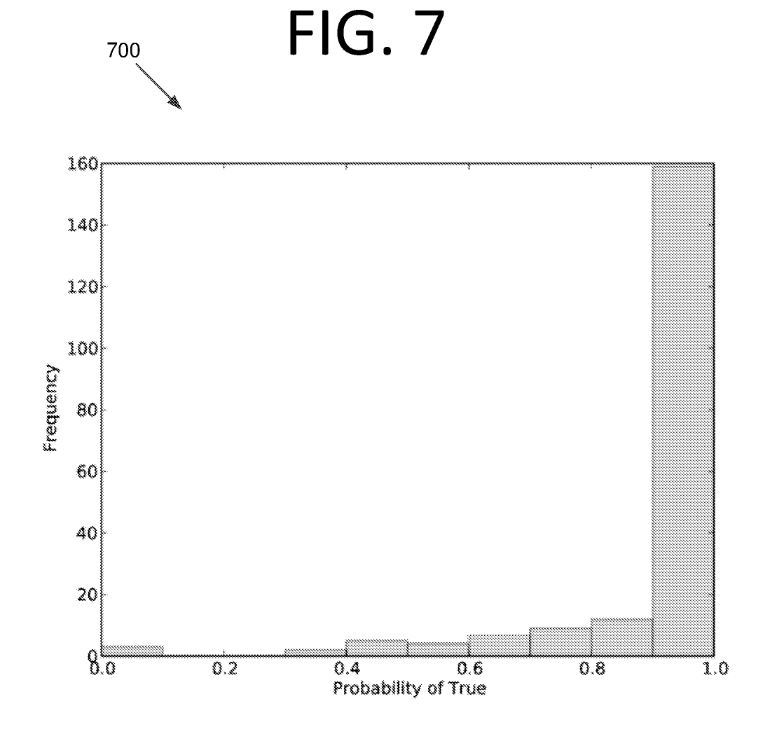

Although API-only classifiers are outperformed by instruction-only classifiers, including API calls significantly improves performance, giving a 98.51% classification accuracy. Furthermore, the average probability of true is increased for both the SVM and the Gaussian process. The increase for the Gaussian process is quite substantial, from 0.8075 to 0.8988. A histogram 700 for the predicted probabilities of the true class for the SVM classifier is shown in FIG. 7.

Testing on a New Family

One of the problems with developing methods with a limited dataset is that it is difficult to know whether the improvements seen on the current dataset will generalize to much larger datasets. This is especially true in the example above, where only 201 subroutines are labeled and a relatively high accuracy of 98.51% is achieved with 10-fold CV. To make the problem more challenging, a new experiment was created where the training data includes all of the subroutines from the first family of malware, the random benign files, and one sample from the second family of malware. The testing set was composed of the subroutines from the remaining samples of the second family of malware.

In addition to allowing for new methodological developments, this test is more realistic. APT malware is usually developed in campaigns. When a new malware sample attacks a network, a reverse engineer has most likely spent time on another sample from that family. Therefore, at least one member of that family's subroutines would be in the training dataset. Table 3 below lists the results for this new experiment

TABLE 3
10-FOLD CV TEST RESULTS FOR NEW FAMILY

| | | | Average Probability |
|---|---|---|---|
| Method: | Views: | Accuracy: | of True: |
| SVM | Instructions | .8000 | .7716 |
| GP | Instructions | .8800 | .5750 |
| SVM | API Calls | .5000 | .5067 |
| GP | API Calls | .4200 | .4132 |
| SVM | API Calls, Neighbor | .9400 | .7955 |
| | Information | | |
| GP | API Calls, Neighbor | .9000 | .6552 |
| | Information | | |
| SVM | Instructions, API Calls | .8400 | .6804 |
| GP | Instructions, API Calls | .8400 | .7228 |
| SVM | Instructions, API | .9400 | .8112 |
| | Calls, Neighbor | | |
| | Information | | |
| GP | Instructions, API | .9400 | .7382 |
| | Calls, Neighbor | | |
| | Information | | |

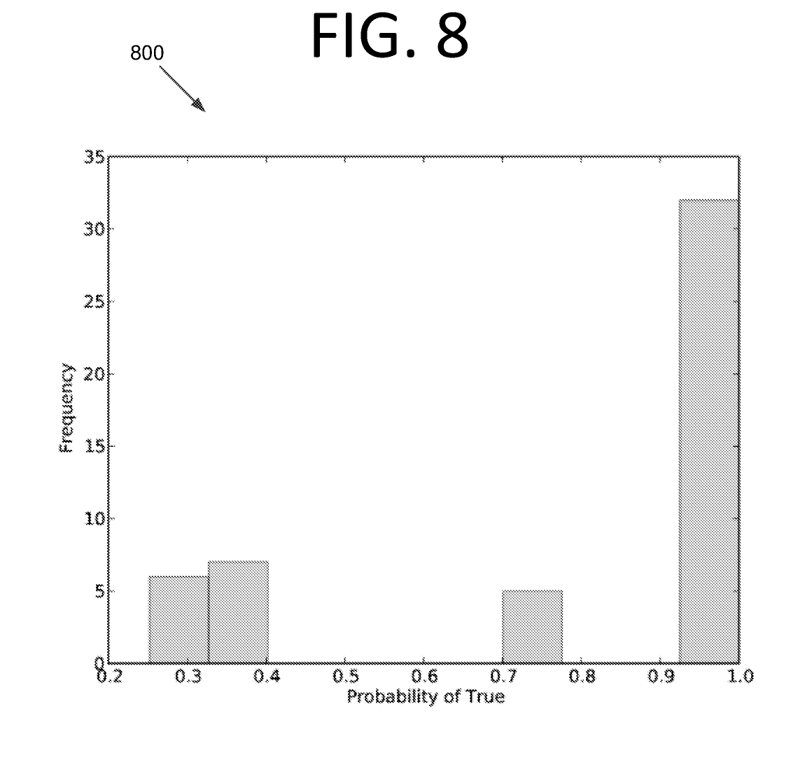

Because this is a more difficult experiment, both accuracy and the average probability of the true class suffer compared to the results of Table 2. With this harder experiment, it is clear that including the neighbor information improves the results. For the Gaussian process, including the neighbor information pushes the accuracy from 90% to 94%, and the average probability of the true class improves from 0.6552 to 0.7382. A histogram 800 for the predicted probability of the true class is shown in FIG. 8. As the dataset is still relatively small, it is difficult to know with certainty whether the neighbor's DLLs will continue to be informative as new data is collected. However, the results of Table 3 indicate that it should be helpful.

Prototype System

FIG. 9 is a screenshot 900 illustrating a prototype GUI, according to an embodiment of the present invention. A reverse engineer was able to check the results to make sure the algorithms were performing in a consistent way. All of the subroutines of a typical program (approximately 400-500) were classified in approximately 5-10 seconds, making the tool very useful in an online setting. The tool also revealed some interesting real world results. The algorithm labeled one subroutine that was not in any training set as being 0.55 network and 0.4 process/thread. After investigating the subroutine, the reverse engineer discovered that this subroutine was looking for threads with an active Internet connection and killing them. Such observations make it clear that not all subroutines are “pure,” and although not disclosed here, having the ability to place a subroutine in multiple classes would provide a more robust system.

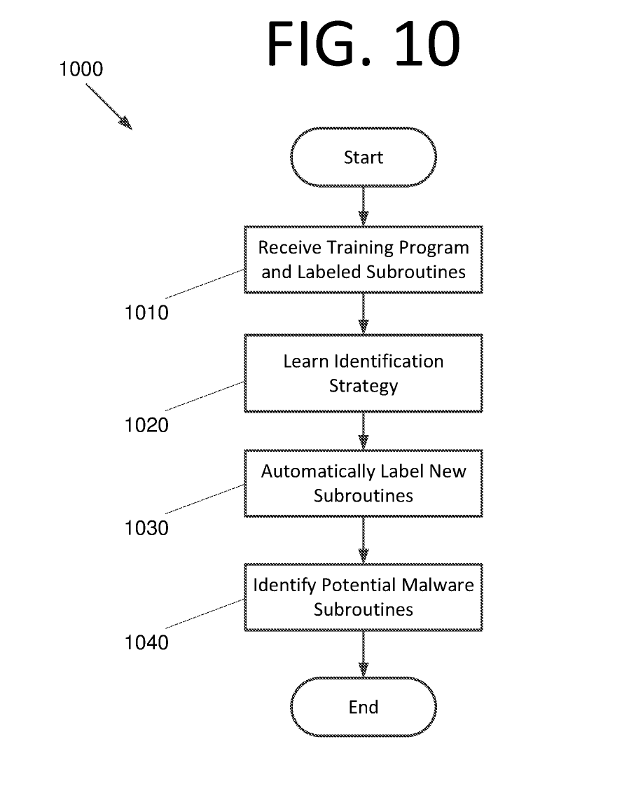

FIG. 10 is a flowchart 1000 illustrating a processor for learning categories and identifying subroutines that are potentially indicative of malware, according to an embodiment of the present invention. The process begins with receiving a training program and list of subroutines labeled in a plurality of categories at 1010. An identification strategy of how to identify the categories is learned based on the received subroutines and labels at 1020. New subroutines that have not previously been analyzed are then automatically labeled in a function call graph at 1030 based on the learned identification strategy. A probabilistic approach is then applied to identify at least one subroutine as potentially indicative of malware at 1040.

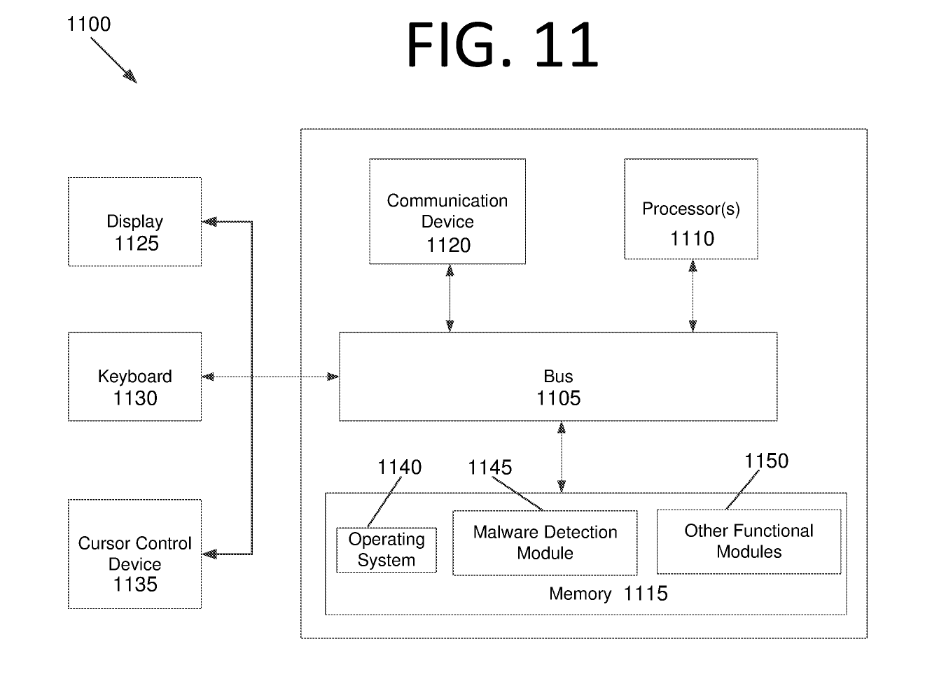

FIG. 11 is a block diagram of a computing system 1100 configured to learn subroutine categories and identify malware, according to an embodiment of the present invention. Computing system 1100 includes a bus 1105 or other communication mechanism for communicating information, and processor(s) 1110 coupled to bus 1105 for processing information. Processor(s) 1110 may be any type of general or specific purpose processor, including a central processing unit (“CPU”) or application specific integrated circuit (“ASIC”). Processor(s) 1110 may also have multiple processing cores, and at least some of the cores may be configured to perform specific functions. Computing system 1100 further includes a memory 1115 for storing information and instructions to be executed by processor(s) 1110. Memory 1115 can be comprised of any combination of random access memory (RAM), read only memory (ROM), flash memory, cache, static storage such as a magnetic or optical disk, or any other types of non-transitory computer-readable media or combinations thereof. Additionally, computing system 1100 includes a communication device 1120, such as a transceiver and antenna, to wirelessly provide access to a communications network.

Non-transitory computer-readable media may be any available media that can be accessed by processor(s) 1110 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 1110 are further coupled via bus 1105 to a display 1125, such as a Liquid Crystal Display (LCD), for displaying information to a user. A keyboard 1130 and a cursor control device 1135, such as a computer mouse, are further coupled to bus 1105 to enable a user to interface with computing system. However, in certain embodiments such as those for mobile computing implementations, a physical keyboard and mouse may not be present, and the user may interact with the device solely through display 1125 and/or a touchpad (not shown). Any type and combination of input devices may be used as a matter of design choice.

Memory 1115 stores software modules that provide functionality when executed by processor(s) 1110. The modules include an operating system 1140 for computing system 1100. The modules further include a malware detection module 1145 that is configured to learn subroutine categories and identify subroutines that are potentially indicative of malware. Computing system 1100 may include one or more additional functional modules 1150 that include additional functionality.

One skilled in the art will appreciate that a “system” could be embodied as an embedded computing system, a personal computer, a server, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 2 and 10 may be performed by a computer program, encoding instructions for the nonlinear adaptive processor to perform at least the processes described in FIGS. 2 and 10, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the processes described in FIGS. 2 and 10, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

Classifying programs as either benign or malicious is an important first step to stopping advanced APT malware, but a simple binary decision does not give the analysts the information they need to properly assess the threat. Accordingly, some embodiments of the present invention help reverse engineers to understand a malicious program more quickly by classifying the subroutines of the function call graph into six general categories: file I/O, process/thread, network, GUI, registry, and exploit. SVMs and Gaussian processes were used for the classification process. In the test of 201 labeled subroutines above, a high accuracy of 98.51% was achieved, indicating that the approach of some embodiments provides reverse engineers with a powerful tool for addressing real world APTs.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method, comprising:
automatically labeling each subroutine in a program, by a computing system, in a function call graph;
applying a probabilistic approach, by the computing system, to identify at least one subroutine as potentially indicative of malware; and
providing an indication of the at least one identified subroutine, by the computing system, to an analyst for further analysis.

2. The computer-implemented method of claim 1, wherein the probabilistic approach further comprises:
modeling subroutine labels, by the computing system, using a Support Vector Machine (SVM) or Gaussian process.

3. The computer-implemented method of claim 1, wherein the automatic labeling of each subroutine further comprises:
labeling each subroutine, by the computing system, as file I/O, process/thread, network, GUI, registry, and/or exploit.

4. The computer-implemented method of claim 1, wherein the automatic labeling of each subroutine further comprises:
using a multiview approach, by the computing system, to construct a subroutine kernel matrix for use in the automatic labeling.

5. The computer-implemented method of claim 4, wherein different views of the multiview approach comprise instructions contained within each subroutine, Application Programming Interface (API) calls contained within each subroutine, and neighbor information for each subroutine.

6. The computer-implemented method of claim 5, wherein any combination of, API calls, neighbor information, and/or API calls is used for classification of each subroutine.

7. The computer-implemented method of claim 1, wherein the automatic labeling further comprises:
using of neighborhood information, by the computing system, to determine subroutine function, with an assumption that neighboring subroutines of a subroutine x are likely to perform a similar function to neighboring subroutines of a subroutine y, given that x and y have a same label.

8. The computer-implemented method of claim 1, further comprising:
receiving a training program and a list of subroutines labeled in a plurality of categories, by the computing system; and
learning an identification strategy of how to identify the categories based on the received list of subroutines and labels, by the computing system, wherein
the automatic labeling of each subroutine is based on the learned identification strategy.

9. The computer-implemented method of claim 8, wherein the subroutines are modeled as a Markov chain with the categories as nodes of a Markov chain graph.

10. The computer-implemented method of claim 1, wherein in the function call graph, edge weights for edges originating at a vertex vᵢ are required to sum to 1, such that Σ_{i→j}eᵢⱼ=1.

11. The computer-implemented method of claim 1, wherein an n×n (n=|V|) adjacency matrix is used to represent the function call graph, where for each entry aᵢⱼ in the matrix, aᵢⱼ=eᵢⱼ.

12. A computer program embodied on a non-transitory computer-readable medium, the program configured to cause at least one processor to:
receive a training program and list of subroutines labeled in a plurality of categories;
learn an identification strategy of how to identify the categories based on the received subroutines and labels; and
label new subroutines based on the learned identification strategy.

13. The computer program of claim 12, the program further configured to cause the at least one processor to:
apply a probabilistic approach to identify at least one subroutine as potentially indicative of malware; and
provide an indication of the at least one identified subroutine, by the computing system, to an analyst for further analysis.

14. The computer program of claim 13, wherein in the function call graph, edge weights for edges originating at a vertex vᵢ are required to sum to 1, such that Σ_{i→j}eᵢⱼ=1.

15. The computer program of claim 13, wherein an n×n (n=|V|) adjacency matrix is used to represent the function call graph, where for each entry aᵢⱼ in the matrix, aᵢⱼ=eᵢⱼ.

16. The computer program of claim 12, wherein the subroutines are modeled as a Markov chain with the categories as nodes of a Markov chain graph.

17. An apparatus, comprising:
memory storing computer program instructions; and
at least one processor configured to execute the stored computer program instructions, wherein the at least one processor, by executing the stored computer program instructions, is configured to:
receive a training program and list of subroutines labeled in a plurality of categories,
learn an identification strategy of how to identify the categories based on the received subroutines and labels,
automatically label new subroutines in a function call graph based on the learned identification strategy, and
apply a probabilistic approach to identify at least one subroutine as potentially indicative of malware.

18. The apparatus of claim 17, wherein the at least one processor is further configured to:
provide an indication of the at least one identified subroutine to an analyst for further analysis.

19. The apparatus of claim 17, wherein the at least one processor is further configured to:
label each subroutine as file I/O, process/thread, network, GUI, registry, and/or exploit.

20. The apparatus of claim 17, wherein the at least one processor is further configured to:
use a multiview approach to construct a subroutine kernel matrix for use in the automatic labeling, wherein
different views of the multiview approach comprise instructions contained within each subroutine, Application Programming Interface (API) calls contained within each subroutine, and neighbor information for each subroutine.
